(19) United States
(12) Patent Application Publication
(10) Pub. No.: US 2007/0054109 A1
(43) Pub. Date: Mar. 8, 2007

(54) Heat-dissipating plate for an electro-optical device

(76) Inventor: Yu-Kai Lin, Hsinchu City (TW)

Correspondence Address: BIRCH STEWART KOLASCH & BIRCH, PO BOX 747, FALLS CHURCH, VA, 22040-0747, US

(21) Appl. No.: 11/594,870

(22) Filed: Nov. 9, 2006

Related U.S. Application Data
(63) Continuation-in-part of application No. 10/992,842, filed on Nov. 22, 2004.

(30) Foreign Application Priority Data
May 28, 2004 (TW) 93208447

(51) Int. Cl. B32B 3/00

(52) U.S. Cl. 428/316.6; 428/317.1; 428/317.5; 428/319.1; 428/156; 428/157; 361/704

(57) ABSTRACT

A heat-dissipating plate includes a heat-dissipating pad sandwiched between the first and second adhesive layers. The heat-dissipating pad is made from foam materials, and has a plurality of air passages formed through a peripheral surface thereof. The first adhesive layer is disposed on the peripheral surface of the heat-dissipating pad, and has a plurality of vents in spatial communication with the air passages in the heat-dissipating pad. The second adhesive layer is disposed on the peripheral surface of the heat-dissipating pad opposite to the first adhesive layer, and has a plurality of vents in spatial communication with the air passages in the heat-dissipating pad.

### CROSS-REFERENCE TO RELATED APPLICATION

This application is a Continuation-in-Part (CIP) of U.S. patent application Ser. No. 10/992,842, which was filed on Nov. 22, 2004, and is pending in the Office.

### FIELD OF THE INVENTION

The invention relates to a heat-dissipating plate, and more particularly to an effective heat-dissipating plate for use in an electro-optical device, such as a plasma TV set, liquid crystal display (LCD) devices, flat panel display device or a flat illumination device.

### BACKGROUND OF THE INVENTION

In a conventional CRT-type T V set, a gun continuously fires a beam of electrons inside a large glass tube to excite the phosphor atoms and causes the phosphor atoms to light up. When different areas of the phosphor coating are lit up with different colors at different intensities, an image is consequently produced. Due to its bulky size, the conventional CRT TV set is rapidly replaced by plasma TVs or LCD devices by virtue of its compact size and its portability.

Due to its lightweight and thinness, the aforementioned LCD device or the plasma TV set can be hung on the wall, thereby minimizing the occupying space and enabling the user to have flexible use of the space in the drawing room. It is noted that in an LCD device or a plasma TV set, a backlight (which generates heat) is disposed behind a display screen (generally flat) to illuminate the latter. During conversion of the electrical energy into the light energy, undesired heat is usually generated to increase the ambient temperature of the backlight. Since the performance of the LCD device increases, the heat generated therefrom consequently is relatively large. In case the heat is not efficiently dissipated from the LCD device, the service life and its functionality and quality thereof will be affected. Moreover, the thinner the LCD device is constructed, the harder the situation becomes for the heat to be dissipated effectively from the LCD device.

Referring to FIG. 1, a partly perspective view of a conventional LCD device 10 is shown to include a heat source (preferably a backlight or a cold cathode fluorescent lamp) 12, a metal frame 14 disposed rearward of the heat source 12 to protect the same from a rearward collision, and a heat-dissipating plate 16 disposed between the heat source 12 and the metal frame 14 in order to transfer the heat generated from the heat source 12 to the metal frame 14 so as lower the ambient temperature of the whole assembly and to dissipate the heat to an exterior of the LCD device. Of course, the display screen is disposed frontward of the heat source 12. To display an image on the display screen, an electrical voltage is applied onto two electrode layers at opposite ends of the liquid crystal layer in a pixel unit of the conventional LCD device in order to convert the orientation of the crystal molecules in the liquid crystal layer.

FIG. 2 is a schematic cross-sectional view showing the structure of the heat-dissipating plate 16 used in the conventional LCD device and is manufactured according to the method disclosed in U.S. patent application publication No. 2002/0011660, titled “Heat-dissipating plate sheet and fabrication method therefore”. As illustrated, the heat-dissipating plate 16 includes a silicon heat-dissipating layer 161 doped with metal powders, and two pressure sensitive adhesion layers 165 disposed at opposite sides of the silicon heat-dissipating layer 161. The pressure sensitive adhesion layers 165 serve the role of securing the heat-dissipating layer 161 between a heat source, such as electronic equipment, and a heat-dissipating plate, such as an aluminum-cooling fin. There are several reasons that hinder the heat dissipation operation from the LCD device shown in FIG. 2. One reason is directly related to the rate or ratio of contact among the metal particles 163 for forming the metal powder.

### SUMMARY OF THE INVENTION

The main object of the present invention is to provide a heat-dissipating plate for an electro-optical device, such as an LCD device or plasma TV set. The heat-dissipating plate thereof provides high effective heat dissipating performance.

In one aspect of the present invention, a heat-dissipating plate is provided for an electro-optical device that includes a heat source and a metal frame disposed rearward of the heat source. The heat-dissipating plate is disposed between the heat source and the metal frame for transferring heat generated by the heat source to the metal frame. The heat-dissipating plate includes a heat-dissipating pad, a first adhesive layer and a second adhesive layer. The heat-dissipating pad is made from foam materials, and has a peripheral surface and a plurality of air passages formed through the peripheral surface. The first adhesive layer is disposed on the peripheral surface of the heat-dissipating pad and adjacent to the heat source, and has a plurality of vents in spatial communication with the air passages in the heat-dissipating pad. The second adhesive layer is disposed on the peripheral surface of the heat-dissipating pad opposite to the first adhesive layer and further attached to the metal frame. The second adhesive layer has a plurality of vents in spatial communication with the air passages in the heat-dissipating pad.

In another aspect of the present invention, a heat-dissipating plate is provided for an electro-optical device that includes a heat source and a metal frame disposed rearward of the heat source. The heat-dissipating plate is disposed between the heat source and the metal frame for transferring heat generated by the heat source to the metal frame. The heat-dissipating plate includes a first heat-dissipating pad, a metal layer, a second heat-dissipating pad, a first adhesive layer and a second adhesive layer. The first heat-dissipating pad is made from foam materials, and has a first peripheral surface and a plurality of air passages formed through the first peripheral surface thereof. The metal layer is disposed on the first peripheral surface of the first heat-dissipating pad. The second heat-dissipating pad is made from foam materials, and has a second peripheral surface and a plurality of air passages formed through the second peripheral surface thereof. The second heat-dissipating pad is disposed on the metal layer in such a manner that the metal layer is sandwiched between the first and second heat-dissipating pads. The first adhesive layer is disposed on the first peripheral surface of the first heat-dissipating pad adjacent to the heat source, and has a plurality of vents in spatial communication with the air passages in the first heat-dissipating pad. The second adhesive layer is disposed the second peripheral surface of the second heat-dissipating pad opposite to the first adhesive layer and further attached to the metal frame. The second adhesive layer has a plurality of vents in spatial communication with the air passages in the second heat-dissipating pad.

Since the foam materials for forming the first and second heat-dissipating pads include a predetermined amount of metal powder and a silicon polymer substance, application of pressure onto the first and second heat-dissipating pads may result in expulsion of air from the heat-dissipating pads, which, in turn, results in increase of contact among metal particles for forming the metal powder, thereby enhancing the heat dissipating effect.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a partly perspective view of a conventional panel display device;

FIG. 2 is a schematic cross-sectional view showing the structure of the heat-dissipating plate used in the conventional panel display device;

FIG. 3 is a partly exploded perspective view of the first embodiment of a heat-dissipating plate of a panel display device according to the present invention;

FIG. 4A is a partly perspective view of the panel display device of the present invention;

FIG. 4B is a graph showing the comparison of the heat dissipating plates used in the conventional and present panel display devices;

FIG. 5 shows a partly exploded perspective view of the second embodiment of the heat-dissipating plate employed in the panel display device of the present invention;

FIG. 6 shows a partly exploded perspective view of the third embodiment of the heat-dissipating plate employed in the panel display device of the present invention;

FIGS. 7 shows a partly exploded perspective view of the fourth embodiment of the heat-dissipating plate employed in the panel display device of the present invention;

FIG. 8A is a partly exploded perspective view of the fifth second embodiment of the heat-dissipating plate employed in the panel display device of the present invention;

FIG. 8B is a schematic cross-sectional view showing the structure of the fifth second embodiment of the heat-dissipating plate employed in the panel display device of the present invention; and

FIG. 9 is a partly exploded and sectional view of the sixth second embodiment of the heat-dissipating plate employed in the panel display device of the present invention.

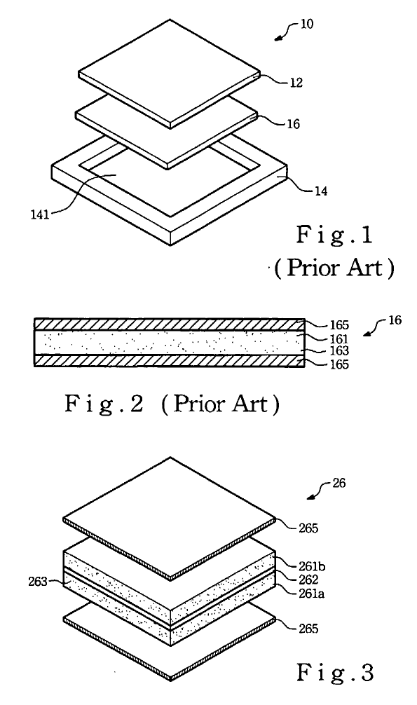

### DETAILED DESCCRIPTIONS OF THE PREFERRED EMBODIMENTS

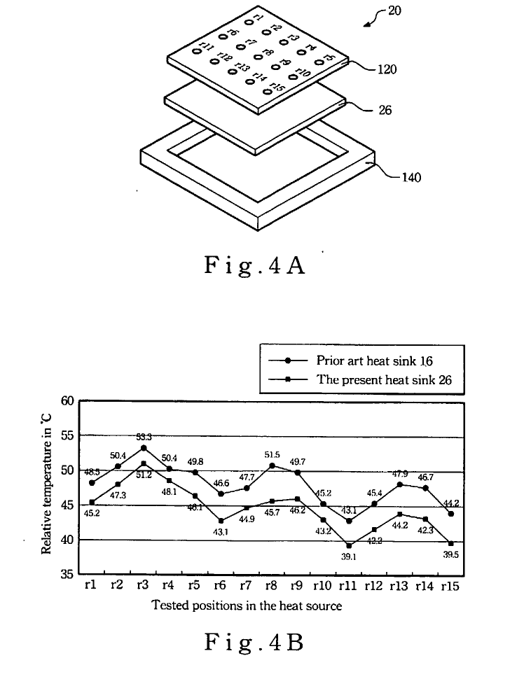

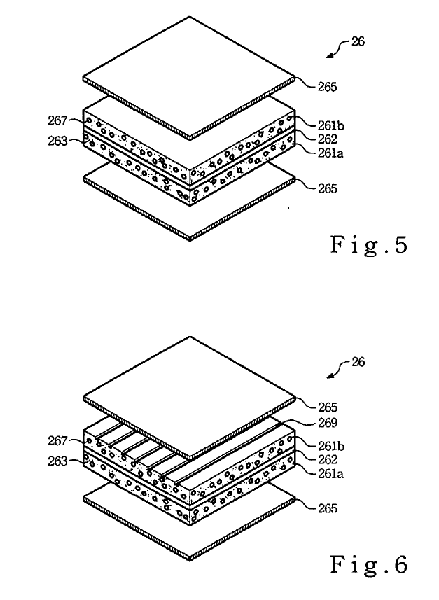

Referring to FIG. 4A, a partly perspective view of a panel display device 20 according to the present invention is shown to include a heat source 120, a metal frame 140 disposed rearward of the heat source 120 to protect the latter from a rearward collision, and a heat-dissipating plate 26 disposed between the heat source 120 and the metal frame 140 in order to transfer heat generated from the heat source 120 to the metal frame 140 so as lower the ambient temperature of the whole assembly. The heat source 120 may be a backlight or a cold cathode fluorescent lamp. Of course, a display screen (not shown) of the Panel display device is disposed frontward of the heat source 120 for displaying an image. Since the relevant feature of the present invention does not reside in the structures of the display screen, a detailed structure thereof is omitted herein for the sake of brevity.

FIG. 3 is a partly exploded and perspective view of the first embodiment of the heat-dissipating plate 26 employed in the panel display device 20 of the present invention, and includes first and second sandwiching pads 261a, 261b and a first metal layer 262 sandwiched between the first and second sandwiching pads 261a, 261b. The first metal layer 262 can be one of the metal materials having high heat conductivity, such as aluminum or copper. Each of the first and second sandwiching pads 261a, 261b can be made from a soft polymeric substance doped with metal powder, such as aluminum powder or copper powder, and silicon polymer fillers such that upon receipt of an applied pressure, the density of each of the first and second sandwiching pads 261a, 261b is increased. The increased density in the first and second sandwiching pads 261a, 261b consequently results in the contact among the metal particles 263 for forming the metal powder, thereby enhancing the heat conductivity effect and the heat dissipating ability of the first and second sandwiching pads 261a, 261b. Of course, two-sided adhesion layers 265 are disposed on the outer surfaces of the first and second sandwiching pads 261a, 261b respectively to facilitate mounting of the heat-dissipating plate 26 onto the heat source 120 and the mounting side of the metal frame 140 (see FIG. 4A).

According to the present invention, two experiments were conducted to test the temperatures, one for the prior art heat-dissipating plate 16 and the other for the present heat-dissipating plate 26 used in the panel display device of the present invention under the conditions that no composite material is altered and each of the heat-dissipating plates 16, 26 has the same total thickness. The temperatures of different tested positions (r1, r2, . . . , r15) (please see FIG. 4A) in the heat source 120 by alternate employment of the prior art heat-dissipating plate 16 and the present heat-dissipating plate 26, are recorded respectively and are compared relative to each other.

FIG. 4B illustrates two graphs respectively representing the tested positions in the heat source 120 and its relative temperatures of the prior art heat-dissipating plate 16 and the present heat-dissipating plate 26. From the above-mentioned graphs, one can observe the heat dissipating ranges of the prior art heat-dissipating plate 16 and those of the present heat-dissipating plate 26. It is noted that the present heat-dissipating plate 26 provides high heat dissipating effect by virtue of its structure and due to the increased density of the sandwiching pads caused by the applied pressure. Generally, the present heat-dissipating plate 26 can lower 3.5° C. when compared to the prior art heat-dissipating plate 16.

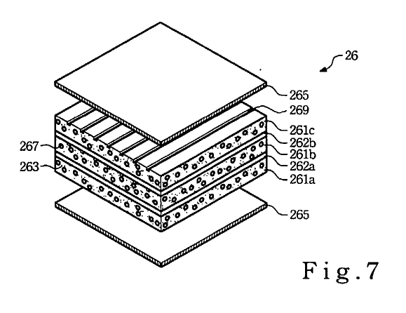

Referring to FIG. 5, the second embodiment of the heat-dissipating plate 26 employed in the panel display device of the present invention is shown to have the structure similar to the previous embodiment. The difference resides in that each of the first and second sandwiching pads 261a; 261b is a foamed member formed with a plurality of evenly distributed bubbled portions 267. When pressure is applied onto the outer surfaces of the foamed members, the air entrapped within the bubbled portions 267 will be expelled therefrom, thereby resulting in the increased density in each of the foamed members so as to enhance the heat dissipating operation thereof.

Referring to FIG. 6, the third embodiment of the heat-dissipating plate 26 employed in the panel display device of the present invention is shown to have the structure similar to that in FIG. 5. The difference resides in that each of the foamed members has an outer surface formed with a plurality of parallel grooves 269, and a plurality of evenly distributed bubbled portions 267 which are located inwardly with respect to the parallel groove 269. When pressure is applied onto the outer surfaces of the foamed members, the air entrapped within the bubbled portions 267 will be expelled therefrom via the parallel grooves 269, thereby resulting in the increased density of each of the foamed members to enhance heat dissipating operation thereof.

Referring to FIG. 7, the fourth embodiment of the heat-dissipating plate 26 employed in the panel display device of the present invention is shown to have the structure similar to those shown in FIGS. 5 and 6. The difference resides in that a third sandwiching pad 261c made also from the soft polymeric substance and doped with metal powder is disposed adjacent to the second sandwiching pad 261b. A second metal layer 262b is sandwiched between the second and third sandwiching pads 261b, 261c. The second metal layer 262b can be one of the metal materials having high heat conductivity, such as aluminum or copper.

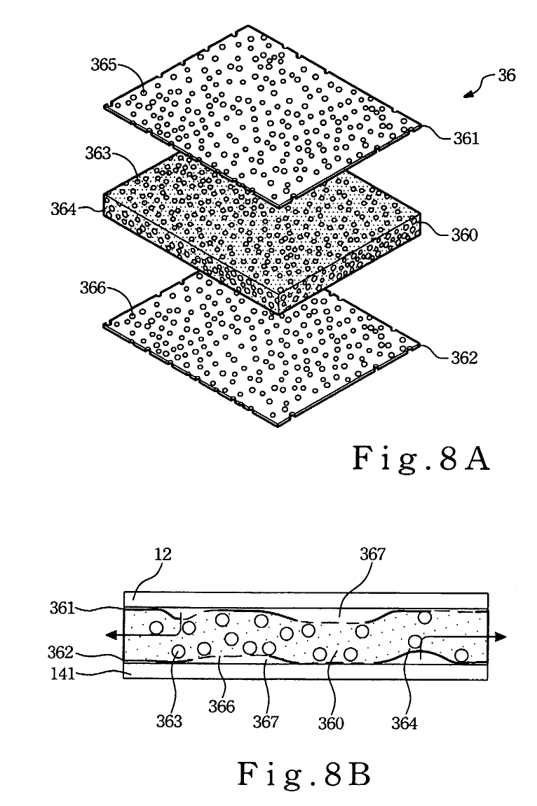

Referring to FIGS. 8A and 8B, partly exploded and sectional views of the fifth second embodiment of the heat-dissipating plate 36 is shown and disposed between the heat source 12 and the metal frame 141 for transferring heat generated by the heat source 12 to the metal frame 141. As shown, the heat-dissipating plate 36 includes a heat-dissipating pad 360, a first adhesive layer 361 and a second adhesive layer 362. The heat-dissipating pad 360 is made from foam materials, and has a peripheral surface confining an entire area of the pad 360 and a plurality of air passages 363 formed the peripheral surface thereof. The first adhesive layer 361 disposed on the peripheral surface of the heat-dissipating pad 360 adjacent to the heat source 12, and has a plurality of vents 365 in spatial communication with the air passages 363 in the heat-dissipating pad 360. The second adhesive layer 362 is disposed on the peripheral surface of the heat-dissipating pad 360 opposite to the first adhesive layer 361 and is further attached to the metal frame 141. The second adhesive layer 362 has a plurality of vents 366 in spatial communication with the air passages 363 in the heat-dissipating pad. Once the first and second adhesive layers 361, 362 are confined between the heat source 12 and the metal frame 141 and because it is relatively difficult to apply the entire surface areas of the first and second adhesive layers 361, 362 in full abutment with the entire surface areas of the heat source 12 and the metal frame 141, several air chambers 367 (see FIG. 8B) will be formed between the first adhesive layer 361 and the heat source 12, and between the second adhesive layer 362 and the metal frame 141 due to the entrapped air. Preferably, the foam materials for forming the heat-dissipating pad 360 include a predetermined amount of metal powder and a silicon polymer substance such that application of pressure onto the heat-dissipating pad 360 may result in expulsion of air from the heat-dissipating pad 360 and the air chamber 367 in the arrow direction, as best shown in FIG. 8B, which, in turn, results in the increase of contact among metal particles 364 for forming the metal powder, thereby enhancing the heat dissipating effect.

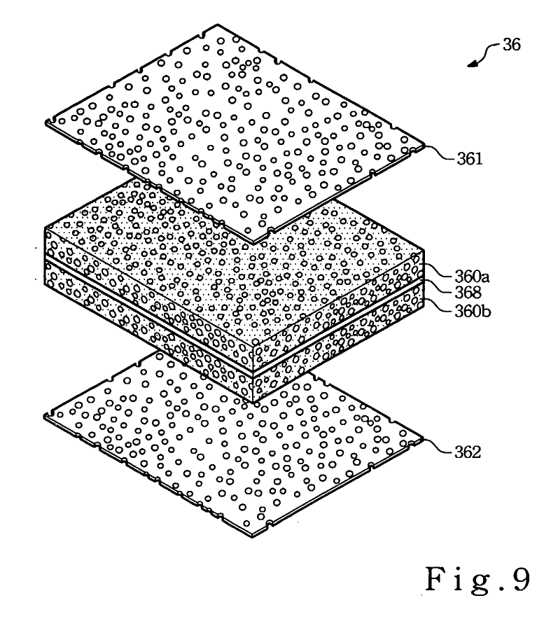

FIG. 9 is a partly exploded and sectional view of the sixth second embodiment of the heat-dissipating plate 36 and disposed between the heat source (not shown) and the metal frame (not shown) for transferring heat generated by the heat source to the metal frame. The heat-dissipating plate 36 includes a first heat-dissipating pad 360a, a metal layer 368, a second heat-dissipating pad 360b, a first adhesive layer 361 and a second adhesive layer 362. The first heat-dissipating pad 360a is made from foam materials, and has a first peripheral surface confining an entire area of the pad 360a and a plurality of air passages formed through the first peripheral surface thereof. The metal layer 368 is disposed on the first peripheral surface of the first heat-dissipating pad 360a. The second heat-dissipating pad 360b is made from foam materials, and has a second peripheral surface confining an entire area of the pad 360b and a plurality of air passages formed through the second peripheral surface thereof. The second heat-dissipating pad 360b is disposed on the metal layer 368 in such a manner that the metal layer 368 is sandwiched between the first and second heat-dissipating pads 360a, 360b. The first adhesive layer 361 is disposed on the first peripheral surface of the first heat-dissipating pad 360a adjacent to the heat source (not shown), and has a plurality of vents in spatial communication with the air passages in the first heat-dissipating pad 360a. The second adhesive layer 362 is disposed on the second peripheral of the second heat-dissipating pad 360b opposite to the first adhesive layer 361 and is further attached to the metal frame (not shown). The second adhesive layer 362 has a plurality of vents in spatial communication with the air passages in the second heat-dissipating pad 360b. Since the foam materials for forming the first and second heat-dissipating pads 360a, 360b include a predetermined amount of metal powder and a silicon polymer substance such that application of pressure onto the first and second heat-dissipating pads 360a, 360b may result in expulsion of air from the first and second heat-dissipating pads 360a, 360b and the air entrapped between the first adhesive layer 361 and the heat source and between the second adhesive layer 362 and the metal frame. The applied pressure simultaneously results in increase of contact among metal particles for forming the metal powder and the silicon polymer substance, thereby enhancing the heat dissipating effect.

While the present invention has been described in connection with preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A heat-dissipating plate for an electro-optical device that includes a heat source and a metal frame disposed rearward of the heat source, the heat-dissipating plate being disposed between the heat source and the metal frame for transferring heat generated by the heat source to the metal frame, the heat-dissipating plate comprising:
a heat-dissipating pad made from foam materials, and having a peripheral surface and a plurality of air passages formed through said peripheral surface thereof;
a first adhesive layer disposed on said peripheral surface of said heat-dissipating pad and adjacent to the heat source, and having a plurality of vents in spatial communication with said air passages in said heat-dissipating pad; and
a second adhesive layer disposed on said peripheral surface of said heat-dissipating pad opposite to said first adhesive layer and further attached to the metal frame, said second adhesive layer having a plurality of vents in spatial communication with said air passages in said heat-dissipating pad.

2. The heat-dissipating plate according to claim 1, wherein said foam materials for forming said heat-dissipating pad include a predetermined amount of metal powder

3. The heat-dissipating plate according to claim 2, wherein said foam materials for forming said heat-dissipating pad further include a silicon polymer substance such that application of pressure onto said heat-dissipating pad may result in increase of contact among metal particles for forming said metal powder so as to enhance a heat dissipating effect.

4. A heat-dissipating plate for an electro-optical device that includes a heat source and a metal frame disposed rearward of the heat source, the heat-dissipating plate being disposed between the heat source and the metal frame for transferring heat generated by the heat source to the metal frame, the heat-dissipating plate comprising:
a first heat-dissipating pad made from foam materials, and having a first peripheral surface and a plurality of air passages formed through said peripheral surface thereof;
a metal layer disposed on said first peripheral surface of said heat-dissipating pad
a second heat-dissipating pad made from foam materials, and having a second peripheral surface and a plurality of air passages formed through said second peripheral surface thereof, said second heat-dissipating pad being disposed on said metal layer in such a manner that said metal layer is sandwiched between said first and second heat-dissipating pads;
a first adhesive layer disposed on said first peripheral surface of said first heat-dissipating pad and adjacent to the heat source, and having a plurality of vents in spatial communication with said air passages in said first heat-dissipating pad; and
a second adhesive layer disposed on said second peripheral surface of said second heat-dissipating pad opposite to said first adhesive layer and further attached to the metal frame, said second adhesive layer having a plurality of vents in spatial communication with said air passages in said second heat-dissipating pad.

5. The heat-dissipating plate according to claim 4, wherein said foam materials for forming said first and second heat-dissipating pads include a predetermined amount of metal powder.

6. The heat-dissipating plate according to claim 5, wherein said foam materials for forming said first and second heat-dissipating pads further include a silicon polymer substance such that application of pressure onto said first and second heat-dissipating pads may result in increase of contact among metal particles for forming said metal powder so as to enhance a heat dissipating effect.
